(19) United States
(12) Patent Application Publication
(10) Pub. No.: US 2009/0004947 A1
(43) Pub. Date: Jan. 1, 2009

(54) MOLDED FABRIC DOLL ACCESSORY

(76) Inventors: Connie Jean Dale, Redondo Beach, CA (US); Chun Fai Yip, Kownloon (HK); Abimael Maelo Cordova, Whittier, CA (US)

Correspondence Address: KOLISCH HARTWELL, P.C., 200 PACIFIC BUILDING, 520 SW YAMHILL STREET, PORTLAND, OR, 97204, US

(21) Appl. No.: 12/111,103

(22) Filed: Apr. 28, 2008

Related U.S. Application Data
(60) Provisional application No. 60/928,743, filed on May 11, 2007.

(51) Int. Cl. A63H 3/36; B29C 51/14

(52) U.S. Cl. 446/268; 264/319

(57) ABSTRACT

In one embodiment, a doll accessory for play or use with a doll or other toy figure is provided. The doll accessory may include a first portion of a doll accessory including a layer of fabric coated with a molding chemical solution and plastically deformed into a substantially resilient three-dimensional shape. A second portion of a doll accessory may be secured to the first portion of a doll accessory. In some embodiments, the second portion of a doll accessory may include a layer of fabric coated with a molding chemical solution and plastically deformed into a substantially resilient three-dimensional shape. In some embodiments, the second portion of a doll accessory may be adhesively bonded to the first portion of a doll accessory.

### RELATED APPLICATIONS

This application claims the benefit of U.S. Provisional Application Nos. 60/926,616, filed Apr. 27, 2007, and 60/928,743, filed May 11, 2007, incorporated herein by reference in their entirety for all purposes.

### BACKGROUND

The present disclosure relates generally to a molded fabric doll accessory, specifically a molded fabric doll accessory that includes a layer of fabric molded into a predetermined three-dimensional shape. Doll accessories, including removable doll clothing, provide a user with the opportunity to play and interact with dolls and other toy figures.

Removable doll clothing and other accessories have been popular toys for many years. However, when fabric doll clothing, or similar doll accessories fashioned from fabrics, are removed from a doll, the fabric doll clothing generally lies flat and formless. An article of fabric doll clothing that is adapted to hold a predetermined shape when removed from a doll may have added play value, as the user may be able to visualize the article of clothing on a doll before dressing the doll. It is known that molded doll clothing fabricated from resins or other polymer materials may hold a predetermined shape when removed from a doll, however doll clothing formed from fabric materials may have a more natural feel.

Examples of dolls and/or doll clothing, including doll clothing that is molded to the exterior shape of a doll or other toy figure, include U.S. Pat. No. 1,485,640, U.S. Pat. No. 1,540,384, U.S. Pat. No. 2,944,368, U.S. Pat. No. 3,834,065, U.S. Pat. No. 4,297,153, U.S. Pat. No. 4,392,257, U.S. Pat. No. 4,414,774, U.S. Pat. No. 4,892,501, U.S. Pat. No. 5,186,673, U.S. Pat. No. 6,568,986, and U.S. Pat. No. 6,227,930, U.S. Patent Application Publication Nos. US20030126673, US20040198155, and US20040087245 and in Canadian Patent No. CA619702. The complete disclosures of the above patents and patent applications are herein incorporated by reference for all purposes.

### SUMMARY

In one embodiment, a doll accessory for play or use with a doll or other toy figure is provided. The doll accessory may include a first portion of a doll accessory including a layer of fabric coated with a molding chemical solution and plastically deformed into a substantially resilient three-dimensional shape. A second portion of a doll accessory may be secured to the first portion of a doll accessory. In some embodiments, the second portion of a doll accessory may include a layer of fabric coated with a molding chemical solution and plastically deformed into a substantially resilient three-dimensional shape. In some embodiments, the second portion of a doll accessory may be adhesively bonded to the first portion of a doll accessory.

An exemplary method for making a doll accessory may include molding a first fabric element coated with a molding chemical solution, wherein molding includes plastically deforming the first fabric element into a substantially resilient three dimensional shape. The first molded fabric element may then be joined and secured to a second fabric element, such that the first fabric element and the second fabric element are joined and secured in an area of fabric interface.

An alternative exemplary method for making a doll accessory may include molding a first piece of fabric impregnated with a molding chemical solution, wherein molding includes plastically deforming the first piece of fabric into a predetermined shape using a mold having mating portions. The mold mating portions may include a raised portion having physical dimensions of at least a portion of a doll accessory, and a recessed portion having a shape corresponding to the raised portion and slightly greater in size than the raised portion. The first piece of fabric may then be secured to a second portion of a doll accessory to form at least a portion of a doll accessory, including applying a binding solution to a marginal area of the first piece of fabric.

### BRIEF DESCRIPTION OF THE DRAWINGS

FIG. 1 is a perspective view of a molded fabric doll accessory according to an embodiment of the present disclosure.

FIG. 2 is an exploded view of a molded fabric doll accessory showing a first portion of a doll accessory and a second portion of a doll accessory in accordance with the present disclosure.

FIG. 3 is a side view of the molded fabric doll accessory of FIG. 2, showing the first portion secured to the second portion to define a seam.

FIG. 4 is a perspective view of an exemplary die cutting process, showing a sheet of fabric, a die for cutting the sheet of fabric, and a cut piece of fabric, in accordance with the present disclosure.

FIG. 5 is a perspective view of a mold mating portion having three mold recesses, one of which is shown containing the cut piece of fabric of FIG. 4.

FIG. 6 is a perspective view of a mold mating portion having three raised mold protrusions.

FIG. 7 is a flow chart of a method of making a molded fabric doll accessory in accordance with the present disclosure.

FIG. 8 is a representation a crystal lattice having an area of plastic deformation because of an applied stress.

### DETAILED DESCRIPTION

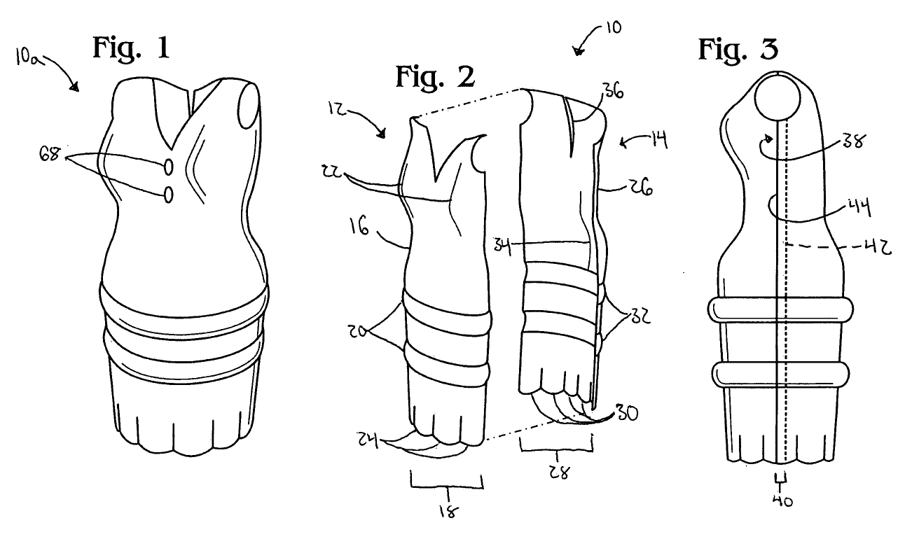

FIG. 1 depicts a perspective view of a molded fabric doll accessory, indicated generally at 10a, according to an embodiment of the present disclosure. Molded fabric doll accessory 10a may be in the form of an article of doll clothing, specifically here a dress, having fabric molded to a predefined three-dimensional shape such as a body shape of a doll figure. Molded fabric doll accessory 10a is adapted to substantially retain a predetermined three-dimensional shape when removed from a doll. It should be appreciated that other embodiments of molded fabric doll accessories may be shaped to define any other doll accessory and/or clothing, including but not limited to, a pair of pants, a jacket, a shoe, a glove, a hat, a purse, or any other doll accessory used with a doll.

FIG. 2 depicts an exploded view of an alternative embodiment of a molded fabric doll accessory, indicated generally at 10. Molded fabric doll accessory 10 may include a first portion 12 of a doll accessory and a second portion 14 of a doll accessory. Alternative embodiments of a molded fabric doll accessory may include more than two portions of a doll accessory. In the exemplary molded fabric doll accessory depicted in FIG. 2, first portion 12 may characterized as the front of molded fabric doll accessory 10, and second portion 14 may be characterized as the back of molded fabric doll accessory 10.

First portion 12 of a doll accessory may include a first piece of molded fabric 16. All or part of first piece of molded fabric 16 may be plastically deformed to include a three-dimensional shape 18. Three-dimensional shape 18 may include any desired predetermined shape or form that is substantially retained by all or part of first piece of molded fabric 16. For example, three-dimensional shape 18 may generally include a three-dimensional shape of a dress front when worn by a doll or other toy figure.

In some embodiments, first piece of molded fabric 16 may include one or more molded contour details or molded fabric contours. Molded fabric contours may generally contribute to the realism or real life aspect of molded fabric doll accessory 10 or alternatively, may add a fantastic or unreal element to a molded fabric doll accessory. Non-limiting examples of molded fabric contours include a dart, a ruffle, a pleat, a pocket, a crease, a wrinkle, fabric texture, ease, style ease, and/or draping of an article of clothing, terms which should be understood by those having skill in the art. In FIG. 2, a horizontal pleat is indicated at 20, a drape of clothing across a woman's chest is indicated at 22, and a ruffle is indicated at 24.

Turning now to FIG. 3, second portion 14 may be secured to first portion 12. In some embodiments, second portion 14 may include a second piece of molded fabric 26. All or part of second piece of molded fabric 26 may be plastically deformed to include a three-dimensional shape 28. Three-dimensional shape 28 may be any desired predetermined shape or form that is substantially retained by all or part of second piece of molded fabric 26. Three-dimensional shape 28 may generally include a three-dimensional shape of a dress back when worn by a doll or other toy figure. Second piece of molded fabric 26 may also include molded fabric contours. For example, a ruffle is indicated at 30, a horizontal pleat is indicated at 32, and a drape of clothing across a woman's behind is indicated at 34.

In alternative embodiments, second portion 14 may be fabricated from any material known to those of skill in the art, including but not limited to, fabric, molded fabric, molded plastic or any other conventional toy accessory material. In some embodiments, a first portion of a piece of molded fabric may be secured to a second portion of the same piece of molded fabric to form a molded fabric doll accessory. For example, a molded fabric doll accessory such as a belt, a scarf, a jacket, a purse, a skirt, a tank top and other non-limiting examples, may be fabricated from a piece of molded fabric wherein a first marginal area of the piece of molded fabric is secured to a second marginal area of the piece of molded fabric.

One or both of first portion 12 and/or second portion 14 may include means of facilitating the removal of molded fabric doll accessory 10 from a doll or other toy figure. For example, second piece of molded fabric 26 may include a slit 36 in substantially the same area where a dress zipper typically is located. In the embodiment shown, slit 36 is open. In other embodiments, slit 36 may include fastening means such as Velcro or a hook and eye closure, such that slit 36 may be opened and/or closed by a user.

Referring to FIG. 3, in some embodiments, first portion 12 may be joined to second portion 14. For example, first piece of molded fabric 16 and second piece of molded fabric 26 may be joined together to form a seam 38. Seam 38 may include an area of fabric interface 40. Area of fabric interface 40 may include a first edge or marginal area 42 of first piece of molded fabric 16 and a second marginal area 44 of second portion 14. Seam 38 may be secured using any known technique, such as gluing, sewing, welding, Velcro, etc. Seam 38 may take any known form of a seam, including but not limited to, a standard seam, a lapped seam, or a butted seam, terms which should be understood by those having skill in the art.

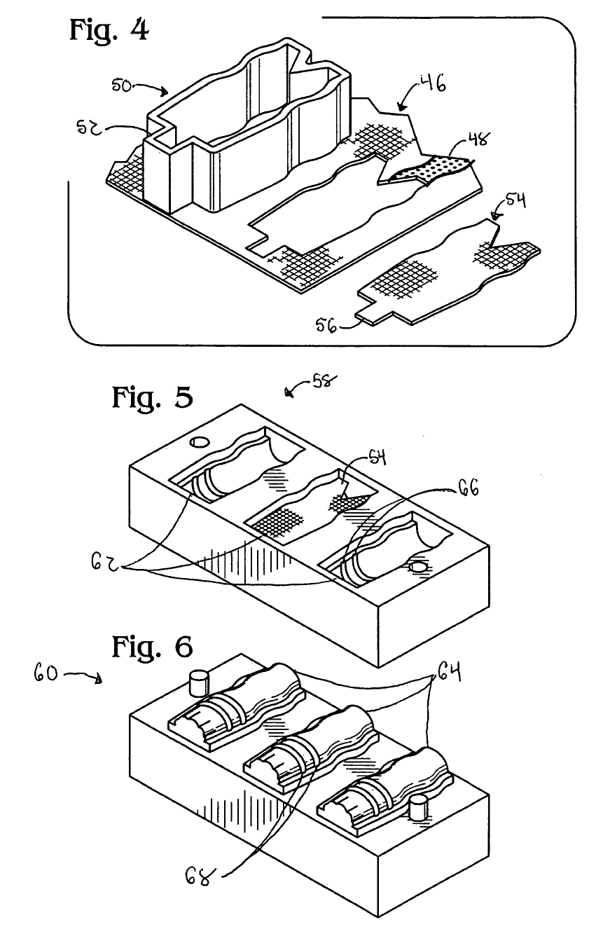

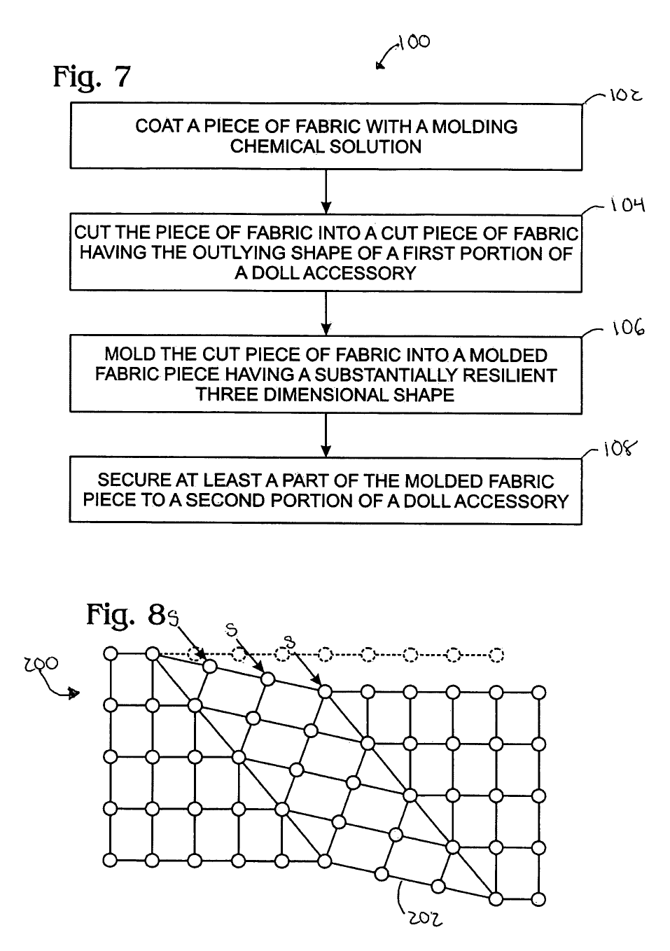

FIGS. 4-7 show non-exclusive examples of fabrication tools and a fabrication process for making molded fabric doll accessories in accordance with the present disclosure. As explained in greater detail below with reference to FIGS. 4-6, an exemplary method for making a doll accessory may include molding a first piece of fabric, or first fabric element, that has been coated and/or impregnated with a molding chemical solution, thereby plastically deforming the first piece of fabric into a substantially resilient three-dimensional shape. The three-dimensional shape may be predetermined by a mold having mating portions including physical dimensions of at least a portion of a doll accessory.

The first piece of fabric may then be joined with a second portion of a doll accessory, or alternatively a second piece of fabric or second fabric element. A binding solution may be applied to a marginal area of the first piece of fabric to secure the two elements together to form a molded fabric doll accessory in accordance with the present disclosure. In some embodiments, the first piece of fabric and the second piece of fabric will be secured in an area of fabric interface.

Molded fabric doll accessories may be fashioned from any fabric that may be plastically deformed to include a substantially resilient three-dimensional shape or, alternatively, any fabric that may be adapted to plastically deform by the addition of a molding chemical solution and/or a foil-dot-screen print or pattern. Like human clothing, different articles or portions of articles may be fabricated from different base fabric or fabrics. For example, a nylon-based spandex, having an example weight of 180 grams per square meter, may be used as fabric in accordance with the present disclosure. Additionally or alternatively, fabric may include a foil-dot-screen print.

Fabrics suitable for use in a molded fabric doll accessory include woven fabrics such as satin, twill, or plain weaves, and/or knit fabrics such as warp or weft knits. Either woven or knitted fabrics may be formed from natural fibers, synthetic fibers, or combinations of natural and/or synthetic fibers. Coloring may be added to the fabrics by dying the yarns prior to weaving or knitting, or by dying the fabric after weaving or knitting. Either brushed tricot knit fabrics or fabrics knitted with other warp and/or weft knitting techniques may be used.

In some examples, patterns may be printed onto fabrics suitable for use in the present disclosure. Optionally, foil-dots may be applied to a piece of fabric by a screen-printing process. The foil-dot-print may allow and/or aid the printed fabric to substantially retain a molded three-dimensional shape. In accordance with the present disclosure, a foil-dot-screen-print may be printed on all or only part of a molded piece of fabric.

As discussed above, fabrics may be formed from yarns spun from natural and/or synthetic fibers. Some non-exclusive examples of natural fibers include cotton, wool, linen, etc. Some non-exclusive examples of synthetic fibers include spandex, polyester, nylon, etc. In some examples, fabrics may be knitted from dyed yarns that are spun from fibers of 8-25% spandex blended with 75-92% either nylon or polyester. Optionally, polyester fibers may be used instead of, or in addition, to spandex and/or nylon fibers.

In accordance with the present disclosure, the fabric chosen for a molded fabric doll accessory may be plastically deformed by an applied stress, such a press-molding operation. FIG. 8 is a non-limiting example of plastic deformation of a crystal lattice. The crystal lattice, indicated generally at 200, includes an area of plastic deformation 202. Generally, in plastic deformation of a crystal lattice, a lattice point may be permanently displaced when a stress, indicated generally by arrows S, is applied. In plastic deformation, crystal lattice 200, though altered by applied stress S, does not fracture or break. Similarly, the fabric chosen for a molded doll accessory may be fabricated from fibers that are configured plastically deform when subject to a press-molding operation.

Additionally, or alternatively, one or more molding chemicals solutions may be applied to a fabric prior to press-molding that may coat one or more fabric fibers or become impregnated within the fabric fibers. Additionally or alternatively, a molding chemical solution may become linked with or bond to the fabric fibers. The coated fabric is configured to substantially retain a pre-determined three-dimensional shape.

Examples of a molding chemical solution may include resins such as acrylic, polyvinyl chloride, polyurethane, latex, adhesive such as glue or emulsion glue, and/or other stiffening agents such as starch and any other resins known to those skilled in the art. The resin may be a thermoplastic or thermosetting resin. Other non-limiting examples of a molding chemical solution may include a copolymer emulsion base such as vinyl acetate-ethylene (VAE) emulsion, polyvinyl alcohol (PVA), polyvinyl acetate (PVAc), PVA emulsion, ethylene vinyl acetate (EVA), etc.

Non-exclusive examples of resins may include KT990 and KT40, which are manufactured by KinTai Super Bond, Ltd, of Hong Kong, and AD-1, which is manufactured by Wholeworld. The resins may be diluted by a thinner or water. For example, a molding chemical solution may include 90% KT40 and 10% water for dilution.

The binding chemical solution may include a mixture of two or more substances at the same or different concentrations. For example, the binding chemical solution may include a mixture of one or more of de-ionized water, a polymer emulsion, a plasticizer, and/or a preservative or preservative blend. The preservative blend may include one or more of Phenoxyethanol, Methylparaben, Ethylparaben, Butylparaben, Propylparaben, and Isobutylparaben.

The below table provides a non-limiting example of a molding chemical solution:

| INGREDIENT | PERCENTAGE |
|---|---|
| De-ionized water | 55.50000 |
| Polymer emulsion, such as Airflex 315 | 36.96000 |
| emulsion, which is manufactured by Air | |
| Products and Chemicals, Inc. of Allentown, | |
| Pennsylvania | |
| Plasticizer, such as Citroflex (Acetylri-n-butyl | 7.04000 |
| Citrate) A-4 manufactured by Moreflex, Inc. of | |
| Greensboro, North Carolina | |
| Preservative blend, such as Phenonip, | 0.50000 |
| manufactured by Clarient, Inc. of Aliso Viejo, | |
| California | |

The percentage or parts per hundred of each substance in a molding chemical solution may vary in accordance with the present disclosure. The molding chemical solution may be applied in a closed heated environment. Alternatively or additionally, one or both of the fabric and the molding chemical solution may be heated prior to application. The molding chemical solution may vary depending on the type of fabric used and the absorption rate.

Application of one or more molding chemical solutions may be performed by spraying, soaking, painting, coating, etc. In some examples, the one or more molding chemical solutions may be injected in a gaseous or steam form during a press-molding operation. Alternatively, large sheets of fabric may be coated with one or more molding chemical solutions using an industrial conveyor, prior to a press-molding operation.

For example, a manufacturer may place a square piece of fabric about 2 ft×2 ft on top of a table with a PU or PVC type top layer. The manufacturer may then pour a bowl of resin, for example white glue as understood by those skilled in the art, on top of the fabric. A scraper may be used to scrap away any excess coating. The resin coated fabric may then be hung up to air dry. Alternatively, drying equipment with temperature control may be used.

After application of the one or more molding chemical solutions, the fabric may be dried prior to a press-molding operation. The fabric may be dried under ambient conditions or heated air may be applied to the fabric in an industrial dryer to speed the drying process. For example, the coated fabric may be dried by passing it through an open chamber at 44 to 54 Celsius, over a period of one hour. Alternatively, the fabric may be inserted in a press mold while wet or damp.

FIGS. 4-6 show non-exclusive examples of fabrication tools for making molded fabric doll accessories in accordance with the present disclosure. Referring to FIG. 4, fabric coated with a molding chemical solution may be cut into cut pieces by a die-cutting operation. A sheet of coated fabric 46 may be laid on a work surface. As discussed above, part or all of sheet of coated fabric 46 may include a foil-dot-screen-print 48. Optionally, multiple sheets of fabric may be stacked together for cutting.

One or more dies 50 may be arranged on sheet of coated fabric 46. Die 50 may have the general outlying shape of a portion of a doll accessory including a die tab 52. Sheet of coated fabric 46 and die 50 may be placed into a cutting press and force may be applied upon die 50 to cut through sheet of coated fabric 46. In other examples, alternate cutting methods, such as laser cutting, sonic cutting, etc., may be used. A cut piece 54 may include tab 56. Tab 56 may facilitate maneuverability of cut piece 54 in a subsequent press-molding operation. Tab 56 may remain in the finished molded fabric doll accessory or may be cut.

Cut piece 54 may be molded using a heat and/or pressure operation. A mold press having two or more mating portions may be used. Referring to FIG. 5, a first mating portion 58 including one or more mold recesses 62 may be positioned in a base of a mold press, not shown. Referring to FIG. 6, a second mating portion 60 including one or more mold protrusions 64 may be positioned in a press head of the mold press. One or more mold recesses 62 and mold protrusions 64 may define the desired three-dimensional shape of the finished molded portion of a doll accessory. For example, a mold protrusion may include a raised portion in the shape of a front of a doll dress, and a mold recess may include a shape corresponding to the raised portion and slightly greater in size than the mold protrusion.

First mating portion 58 and second mating portion 60 may include one or more mold contour details etched into or raised from mold recesses 62 and/or mold protrusions 64, defining the desired molded contour detail(s) of the finished molded portion of a doll accessory. As shown in FIG. 5, a mold contour detail may include a horizontal pleat contour concavity 66. As shown in FIG. 6, a mold contour detail may include pleat contour convexity 68.

In accordance with the present disclosure, in a press-molding operation, cut piece 54 may be placed in mold recess 62. Second mating portion 60 may be lowered to press against first mating portion 58, thereby molding cut piece 54 to the desired three-dimensional shape. After a predetermined period of time, for example five seconds, ten seconds, twenty seconds, or thirty seconds, or range of time, for example four to six seconds, second mating portion 60 may be separated from first mating portion 58, and the, now molded, piece of fabric may be removed.

The molding time and/or molding temperature may be different for different fabric types or different mold contour details. For example, the first mating portion and the second mating portion may be heated to between 180 degrees and 200 degrees Celsius, the heat set time may be 4˜6 sec/1PC at 80 pounds per square inch (PSI). In some examples, increasing the molding temperature and/or the molding time may burn or otherwise damage the fabric, or cause the fabric to fail to mold to the desired contour.

Whereas a vertical arrangement of a mold press is described, other arrangements may be used. Moreover, the position of mold recesses 62 and mold protrusions 64 may be inverted such that the protrusions are formed on first mating portion 58. Optionally, the base of the mold press may be raised to press first mating portion 58 against second mating portion 60.

A mold press may include one or more control systems that may be adapted to apply heat to a first mating portion and/or a second mating portion. For example, the first mating portion and the second mating portion may be heated to between 180 degrees and 200 degrees Celsius during a molding operation. Other functions of the one or more control systems may include measuring and controlling pressure applied between a first mating portion and a second mating portion, injecting one or more substances between the mold portions, and/or to actuating a press head and timing the actuation.

Press-mold mating portions may be formed from one or materials that have the mechanical and thermal stability to withstand the heat-molding process. Materials with high heat conductivity and/or heat capacity may be adapted to provide for more effective heat-molding. For example, a mating portion may be fabricated from a block of metal such as aluminum that has contours carved out of a central region to form a mold recess. Similarly, materials that are non-reactive with the chemicals used for the molding process and/or at the molding temperatures may be used. For example, alloys such as blends of copper and beryllium may be used.

As discussed above, a first portion and a second portion of a molded fabric doll accessory may be joined and/or secured together. A first marginal area of the first portion, and a second marginal area of the second portion may abut or may overlap one another, to form a seam. A binding, or resin, solution such as a glue or adhesive solution may be applied one or both of the first marginal area and/or the second marginal area. The binding solution may include water-soluble and/or solvent-soluble adhesives. The binding solution may include any and/or all of the substances and/or mixtures discussed earlier with reference to the molding chemical solution.

In some embodiments, the binding solution may have substantially the same composition as the molding chemical solution. Additionally or alternatively, the molding chemical solution may be a diluted binding solution or may have a lower viscosity than the binding solution. In other embodiments, the binding solution may be an adhesion enhancer to activate or wet the molding chemical solution on the coated fabric. For example, the adhesion enhancer may be water.

The binding solution may set or dry under ambient conditions or may require a heat treatment to form the seam. In some examples, a form or figure may be provided for the binding process. The form may be a mannequin-like mold or post upon which the portions of a doll accessory may be draped before being joined. Optionally, portions of a doll accessory may be placed in a recessed mold that may be similar to first mating portion 58. The completed molded fabric doll accessory may be placed in a carrier to allow for the binding solution to set. The carrier may be adapted to protect the molded doll accessory for storage and/or shipping.

In some examples, a molding chemical solution may be used as a binding solution. Additionally or alternatively, the molding chemical solution may have a first concentration and the binding solution may have a second concentration, higher than the first concentration. Alternatively, no binding solution may be used.

In other examples, a first marginal area and a second marginal area may be pressed together and heat may be applied to melt or weld the edges together to form a seam. In still other examples, the first marginal area and the second marginal area may be sewn together.

The coating, cutting, molding, and/or securing processes may be performed manually with the aid of one or more machines or tools, or one of more of these operations may be completely automated.

Molded fabric doll accessories may employ a variety of play themes, for example that of a fashionable woman, a fashionable man, or a pirate theme. Molded fabric doll accessories may include one or more decorative features or adornments in accordance with the play theme. Adornments may include, but are not limited to, embroidery, a belt, a pocket, a collar, a sash, a bow, a appliqué, a button, and/or jewelry. Referring to FIG. 1, molded fabric doll accessory 10a may employ a theme of a fashionable woman including button 68. Some embodiments may include an attached key chain to facilitate portability and collectivity of the molded fabric doll accessories. For example, a user may collect and transport multiple molded fabric doll accessories having a key chain on a key ring.

It is believed that the disclosure set forth above encompasses multiple distinct inventions with independent utility. While each of these inventions has been disclosed in its preferred form, the specific embodiments thereof as disclosed and illustrated herein are not to be considered in a limiting sense as numerous variations are possible. The subject matter of the inventions includes all novel and non-obvious combinations and subcombinations of the various elements, features, functions and/or properties disclosed herein. Where the claims recite “a” or “a first” element or the equivalent thereof, such claims include one or more such elements, neither requiring nor excluding two or more such elements. Further, ordinal indicators, such as first, second or third, for identified elements are used to distinguish between the elements, and do not indicate a required or limited number of such elements, and do not indicate a particular position or order of such elements unless otherwise specifically stated.

Inventions embodied in various combinations and subcombinations of features, functions, elements, and/or properties may be claimed through presentation of claims in a related application. Such claims, whether directed to different inventions or directed to the same invention, whether different, broader, narrower or equal in scope, are also regarded as included within the subject matter of the present disclosure.

What is claimed is:

1. A method for making a doll accessory comprising;
molding a first fabric element coated with a molding chemical solution including plastically deforming the first fabric element into a substantially resilient three dimensional shape;
joining the first fabric element to a second fabric element such that the first fabric element and the second fabric element have an area of fabric interface; and
securing the first fabric element to the second fabric element in the area of fabric interface.

2. The method of claim 1, wherein securing the first fabric element to the second fabric element includes applying a binding solution to the area of fabric interface.

3. The method of claim 2, wherein the molding chemical solution includes a plasticizer.

4. The method of claim 1, further including coating the first fabric element with the molding chemical solution prior to molding.

5. The method of claim 1, wherein the first fabric element and the second fabric element together form an article of doll clothing.

6. The method of claim 1, wherein the first fabric element includes a nylon-based spandex having a foil-dot-screen-print.

7. The method of claim 1, wherein molding the first fabric element includes heating mating portions of a mold to between 180 and 220 degrees Celsius and molding the first piece of fabric for between 4 and 6 seconds using approximately 80 pounds per square inch of pressure.

8. A method for making a doll accessory comprising;
molding a first piece of fabric impregnated with a molding chemical solution including plastically deforming the first piece of fabric into a predetermined three-dimensional shape, using a mold having mating portions including a raised portion having physical dimensions of at least a portion of a doll accessory, and a recessed portion having a shape corresponding to the raised portion and slightly greater in size than the raised portion;
securing a marginal area of the first piece of fabric to a second portion of a doll accessory to form at least a part of a doll accessory, including applying a binding solution to the marginal area of the first piece of fabric.

9. The method of claim 8, wherein molding the first piece of fabric includes heating the mating portions of the mold to between 180 degrees and 200 degrees Celsius.

10. The method of claim 8, wherein the first piece of fabric and the second portion of a doll accessory together form an article of doll clothing.

11. The method of claim 8, wherein the first piece of fabric includes a foil-dot-screen-print.

12. The method of claim 8, wherein the first piece of fabric includes a tab to facilitate removal from the mold.

13. The method of claim 8, wherein the first piece of fabric includes a nylon-based spandex.

14. The method of claim 8, wherein a mold mating portion includes at least one mold contour detail for impressing a predetermined molded fabric contour into the first piece of fabric.

15. A doll accessory comprising;
a first portion of a doll accessory including a first layer of fabric coated with a molding chemical solution and plastically deformed into a first substantially resilient three-dimensional shape; and
a second portion of a doll accessory secured to the first portion of a doll accessory to form an article of doll clothing.

16. The doll accessory of claim 15, wherein the layer of fabric includes a nylon-based spandex having a foil-dot-screen-print.

17. The doll accessory of claim 15, wherein the wherein the first portion of a doll accessory includes a slit to facilitate removal of the doll accessory from a doll.

18. The doll accessory of claim 15, wherein the second portion of a doll accessory includes a second layer of fabric coated with the molding chemical solution and plastically deformed into a second substantially resilient three-dimensional shape.

19. The doll accessory of claim 15, wherein the first three-dimensional shape includes one or more molded fabric contours.

20. The doll accessory of claim 15, wherein the second portion of a doll accessory is adhesively bonded to the first portion of a doll accessory.
